(19) United States
(12) Patent Application Publication
(10) Pub. No.: US 2009/0302533 A1
(43) Pub. Date: Dec. 10, 2009

(54) GAME TABLE WITH HIDDEN DISPLAY

(76) Inventor: Samuel G. Smith, Newburgh, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/479,240

(22) Filed: Jun. 5, 2009

Related U.S. Application Data
(60) Provisional application No. 61/059,110, filed on Jun. 5, 2008.

(51) Int. Cl. A63F 7/07; A63F 13/00

(52) U.S. Cl. 273/108.1; 463/31

(57) ABSTRACT

A game table includes a game playing surface, a display covering and a railing extending around the perimeter of and slightly above the game playing surface. The game table also includes a display unit having a display screen. The display unit may be embedded within the railing, with the covering positioned over the display screen. The covering is illuminated from behind to allow illuminated game status information from the display unit to be visible. The covering is configured to substantially conceal the display unit beneath the covering when not lit, yet allows illumination from the display unit to transmit through the covering when lit.

### CROSS-REFERENCE TO RELATED APPLICATIONS

This application claims the benefit of U.S. Provisional Application No. 61/059,110, filed Jun. 5, 2008, which is hereby incorporated by reference.

### FIELD OF THE DISCLOSURE

The present disclosure relates generally to game tables, and more particularly to game tables having a hidden display.

### BACKGROUND OF THE DISCLOSURE

Watching and participating in sporting events and games is a popular pastime for many people. However, due to time, space and the number of people needed for most such games, it is not always practical to arrange a full-scale game at any particular time. Moreover, due to the skill and physical conditioning required, plus the potential injuries from many such games, individuals are not always prepared to participate in a full-scale game. As a spin-off from full-scale games, recreational game tables such as for table soccer (sometimes called foosball), air hockey or field hockey have become popular. Game tables allow the participants to simulate a full-sized game with fewer people, less space and in a protected environment. Such games can, for example, be set up in basements, garages, game rooms, backyards, gyms, party facilities or otherwise and are often played with two or four people.

There have been various approaches to designing and constructing game tables for air hockey, table soccer, field hockey, and similar games, as well as the associated game table accessories. Additionally, often when playing these games, each team's score from point to point is merely remembered by each player along with the time elapsed or remaining as corresponds with the game. Although usually a reliable system, if a player is distracted or the player's concentration is broken, it may lead to the player mis-remembering the score or forgetting a time period. Conversely, if a player is concentrating on the score or time, it may distract the player's attention from the game in progress. In the past, attempts to display the score and time for similar table games have involved bulky and/or complex manual or electric components associated with the table. Such displays frequently take additional game-playing space, physically interfere with the game-playing area and/or are difficult for the players to read. This can distract players and interfere with game play. Accordingly, there is a need for an improved method of displaying the score, time periods, and/or other information for table games.

The present disclosure addresses these needs, among others.

### SUMMARY OF THE DISCLOSURE

In certain embodiments, a game table has a game playing surface and a railing. The railing extends around the perimeter of the game playing surface and extends at least slightly above the game playing surface to prevent escape of a game playing piece from the game playing surface, the railing having a top surface. The game table includes at least one display unit having a display screen, the display unit being mounted within the railing such that the display screen is positioned substantially flush with or slightly below the top surface of the railing. Te display unit is operable to illuminate to provide game status information when lit. Additionally, the game table includes a covering positioned over the display screen, the covering being configured to substantially conceal the display unit beneath the covering when not lit, yet allows illumination from the display unit to transmit through the covering when lit. Further, the game table includes an electrical controller electrically coupled to the display unit.

In certain other embodiments, a game table has a game playing surface, a display covering and a railing extending around the perimeter of and slightly above the game playing surface, the railing having a top surface. The game table includes a display unit having a display screen, the display unit being embedded within the railing with the display covering positioned over the display screen. The covering is illuminated from behind to allow illuminated game status information from the display unit to be visible. Additionally, the covering is configured to substantially conceal the display unit beneath the covering when not lit, yet allows illumination from the display unit to transmit through the covering when lit.

In yet other embodiments, a hockey game table has first and second parallel player ends along a width direction, first and second parallel longitudinal sides along a length direction, and a game playing surface defined within the player ends and the longitudinal sides. Each of the player ends includes a goal. The hockey game table includes a railing extending around the perimeter of the game playing surface and extending at least slightly above the game playing surface to prevent escape of a game playing piece from the game playing surface, the railing having a top surface. The game table also includes at least one display unit having a display screen, the display unit being embedded within the railing. The display unit is operable to illuminate to provide at least one game status indicator when lit. The game status indicator may include the score of the game being played on the game table. Additionally, the game table includes a covering positioned over the display screen, the covering being configured to substantially conceal the display unit beneath the covering when not lit, yet allows illumination from the display unit to transmit through the covering when lit. The covering has a top surface, with either the top surface of the covering or the display screen being positioned substantially flush with the top surface of the railing. The game table further includes an electrical controller electrically coupled to the display unit and operable to transmit signals to the display unit to update the score of the game illuminated through the covering. Additionally, the game table includes at least one sensor associated with each of the goal openings operable to detect passage of a playing piece through the respective opening, the sensor being electrically coupled to the electrical controller and operable to transmit scoring signals to the electrical controller.

### BRIEF DESCRIPTION OF THE DRAWINGS

FIG. 1 is a perspective view of a game table according to an embodiment of the present disclosure.

FIG. 2 is a perspective view of a portion of the game table of FIG. 1.

FIG. 3 is a side, cross-sectional view of a portion of the game table according to the embodiment of FIG. 1.

FIG. 4 is a side, cross-sectional view of a portion of a game table according to another embodiment of the present disclosure.

FIG. 5 is a perspective view of a portion of a game table according to an embodiment of the present disclosure.

### DESCRIPTION OF THE ILLUSTRATED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates.

In certain embodiments of the present disclosure a game table is provided with improved characteristics. According to certain embodiments of the present disclosure, the game table provides a hidden scoring display via an LED display unit mounted or embedded in the upper frame of the game table. In certain embodiments, the LED display unit is mounted flush with the railing defining the structure of the frame and one or more coverings are placed over the railing and the LED display unit, thereby concealing the unit. When the display unit is activated, the LEDs incorporated into the unit provide illumination through the covering so that the score, and possibly other game status indicators, are visible and legible. The hidden scoring display provides visibility of game status information to the players while minimizing any obstruction or distraction to the game and is concealed when not in use. The game table may be configured for use with a variety of possible table games such as soccer (also called foosball), ice or field hockey, billiards, table tennis, air hockey, and/or multi-game table combinations, although the illustrated examples will include an air hockey table and a billiards table.

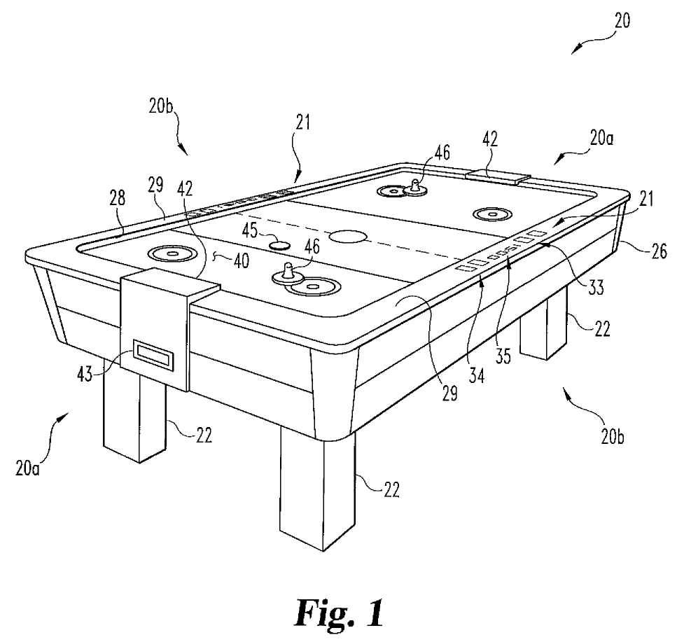

An embodiment of an air hockey table according to the present disclosure is illustrated in FIG. 1. FIG. 1 illustrates an air hockey game table 20 having hidden display 21. Game table 20 is generally a standard style of game table having legs 22 supporting a polygonal table bed 26. Table bed 26, shown in FIG. 1 in a generally rectangular shape, is the primary superstructure of game table 20. In the illustrated embodiment, game table 20 includes parallel and opposing player ends 20a and parallel and opposing longitudinal sides 20b. Legs 22 are standard support structures for a table, and may, for example, be four corner legs or one or more central pedestals supporting the table bed 26. In certain embodiments, table 20 includes a frame 28 mounted to the table bed 26. Frame 28 surrounds and extends above a game playing surface 40 a height normally sufficient to block escape of a playing piece from the table. Typical heights can be from ¾ of an inch to six or more inches as a design choice for a particular game. In the illustrated embodiment, frame 28 defines openings or goals 42 at opposing player ends of table 20 for passage of a playing piece. In certain embodiments, frame 28 may include rubber or felt bumpers around the inside perimeter.

Game playing surface 40 has a polygonal shape and is configured to be mounted to or otherwise positioned on table bed 26. The game playing surface 40 extends across the area defined within frame 28 to form a playing area. The game playing surface may be mounted to the frame 28 or extend underneath the lower edges of frame 28. Playing surface 40 may rest in place or can be attached using standard methods such as adhesive, friction, screws, bolts or other permanent or removable connectors. Playing surface 40 is appropriately sized and configured for the desired game, for example with air holes aligned with air ducts (not shown) for an air hockey game. In certain embodiments, surface 40 may be composed of a durable plastic material (such as a thick polyethylene or Plexiglass®) or glass. During play of a typical air hockey game, players stand adjacent player ends 20a and manipulate strikers 46 to urge a hockey puck 45 into the opposing player's goal 42 to score points. In certain embodiments, puck 45 will travel through goal 42 to outlet 43 where the puck can be accessed by a player to resume game play.

Further illustrated in FIG. 1 are hidden displays 21 which are visible on game table 20. In certain embodiments, each hidden display 21 is comprised of one or more LED display units mounted within the frame. Frame 28 includes a covering 29 positioned over and thus covering the LED display units mounted within the frame. In such embodiments, when lit the LEDs on the display unit will illuminate through covering 29 to reveal hidden display 21. In this way, the covering 29 reveals light from behind via the illumination from the display unit which is visible through the covering.

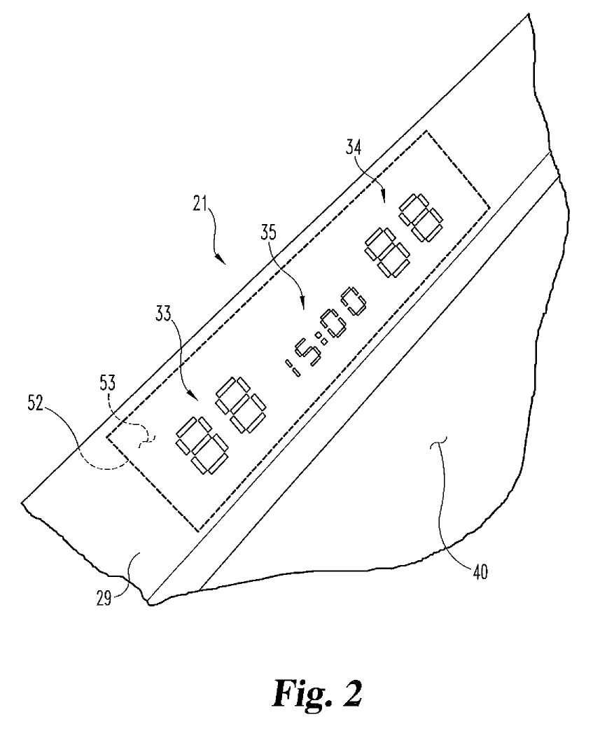

FIG. 2 is a close-up, perspective view of a portion of game table 20, showing one hidden display 21 via an LED display unit 52 mounted within one of the rails of the game table. Display unit 52 has a display screen 53 providing illumination that is visible through covering 29. In certain embodiments, covering 29 comprises sufficient degrees of both opaque and transparent qualities. More specifically, covering 29 may be sufficiently opaque such that display unit 52 is substantially not visible through the covering when not lit, yet sufficiently transparent such that illumination from the LEDs incorporated in the display unit 52 is visible through the covering to display game status information.

In the illustrated example, hidden display 21 has different display portions including a first score 33, a second score 34, and a timer 35 showing the time remaining in the game. However, it should be appreciated that the hidden display could show only the score display or only the timer display. Further, the display could show other game status indicators as would occur to one skilled in the art. As examples, the display may show the period of the game, the time elapsed in the period or the game, the possession of the puck, the team names, the high scores, the scoring records, etc. Also, in certain embodiments the display may include words such as “Home” and “Visitor” to differentiate the first and second scores.

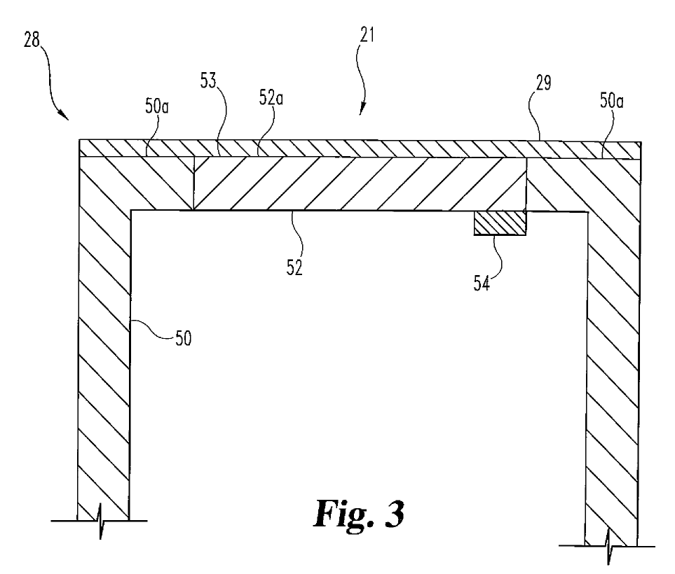

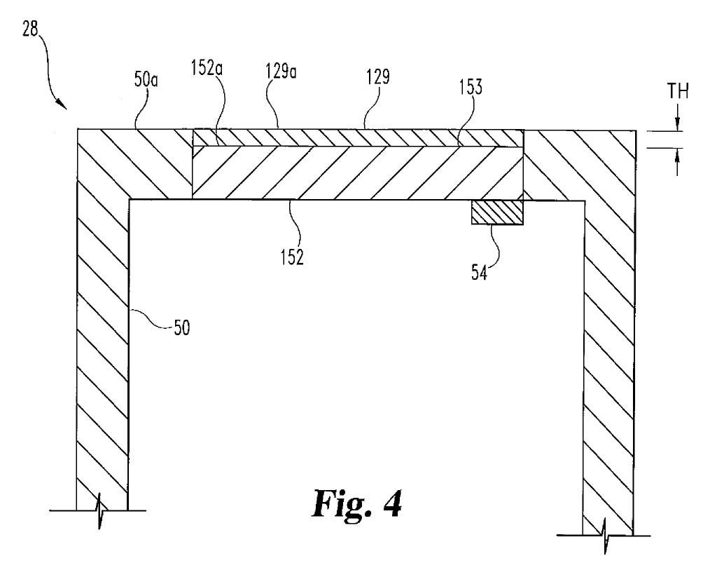

FIGS. 3 and 4 are close-up, cross-sectional views of a portion of a game table, showing two different example manners in which an LED display unit may be mounted within the frame of the game table. In both illustrated embodiments, frame 28 includes one or more rails 50 defining the frame, with an LED display unit 52 (FIG. 3) or 152 (FIG. 4) mounted within one of the rails. The LED display units 52 and/or 152 may be electrically coupled to an integrated or remotely positioned electrical power and control component 54 with corresponding connections.

In the embodiment illustrated in FIG. 3, display screen 53 of LED display unit 52, which also serves as the top surface 52a of the LED display unit 52, is positioned flush and in alignment with top surface 50a of rail 50, creating a smooth appearance along the top of frame 28. LED display unit 52 is snugly mounted in a hole or cavity created in rail 50 with essentially no gaps being present between the edges of unit 52 and rail 50. Although the illustrated embodiment shows LED display unit 52 having the same thickness as frame 50, it should be appreciated that the thickness of LED panel 52 may be greater or less than as illustrated, with the top surface 52a of the display unit remaining flush with the top surface 50a of the rail. As illustrated, covering 29 is placed over rail 50 and LED display unit 52.

In the embodiment illustrated in FIG. 4, display unit 152 is snugly mounted within an opening or cavity created in rail 50 with top surface 152a (aligned with display screen 153) being offset from top surface 50a of the rail. Additionally, in some embodiments, essentially no gaps are present between the edges of unit 152 and rail 50. In the illustrated embodiment, the display unit 152 is offset from the top surface 50a by a distance TH equal to the thickness of the covering 129 positioned over the display unit. In this way, the top surface 129a of the covering 129 is positioned flush and aligned with top surface 50a of rail 50 to create a smooth appearance along the top of the rail. It should be appreciated that, in certain embodiments, the thickness of coverings 29 and 129 shown in FIGS. 3 and 4 is exaggerated for clarity. In such embodiments, the coverings may be composed of a thin film material of a relatively small thickness. Additionally, the LED display unit contemplated by the present disclosure may be mounted within frame 28 in a variety of possible manners, including different mounting fasteners and/or adhesive materials. Additionally, it is contemplated that rails 50 may be comprised of a variety of possible materials, including plywood, metal, wood, laminate, particleboard, MDF or plastic, as examples.

In certain embodiments, coverings 29 and/or 129 may be composed of a thicker, more rigid material. As an example, coverings 29 and/or 129 may be composed of a laminate material. In other embodiments, coverings 29 and/or 129 may be composed of a thin and flexible film material, such as a decal for example. Additionally, numerous possible mechanisms for creating the necessary, desired and/or sufficient degree of opaqueness in coverings 29 and/or 129 are contemplated by the present disclosure. As an example, coverings 29 and/or 129 may be tinted so that the display unit is substantially concealed when not lit. Additionally, coverings 29 and/or 129 may be composed of a sufficiently dark colored material to conceal the display unit when not lit. As another example, coverings 29 and/or 129 may include an interference pattern, such as a dotted pattern, which functions to substantially conceal the unlit display unit. Additionally, coverings 29 and/or 129 may be configured with a camouflaged or decorative pattern that is capable of concealing the display unit when not lit, including a wood pattern as one example. Further, coverings 29 and/or 129 may be sufficiently thin that the contrasting color of the LEDs penetrates through the opaque quality of the covering. However, it should be appreciated that coverings 29 and/or 129 can be decorated, designed and/or colored in a variety of different ways such that coverings function to conceal the LED display units when not in use. Coverings 29 and/or 129 may consist of a single covering sheet or multiple pieces of covering material. Additionally, in certain embodiments, coverings 29 and/or 129 may be selectively engaged with the respective top surfaces such that the coverings may be removed from the surfaces and positioned back on the surfaces as desired.

Additionally, it should be appreciated that the numbers and/or letters of display 21 may be displayed in relatively bright, visible colors, such that the letters and/or numbers are visible through covering 29. The numbers and/or letters may also be shown in multiple colors, as desired. Further, the numbers and/or letters shown in display 21 are preferably sized large enough so that they are visible to players playing a game on table 20, as well as any members of an audience watching the game, but not so large as to provide a distraction to the game or to be difficult to easily read.

The illustrated example in FIG. 1 shows two displays 21 centrally located along the top of frame 28 at sides 20b of table 20. However, it should be appreciated that table 20 could include more or less than two displays as desired. Additionally, the display(s) can be positioned at other locations along the sides and/or ends of table 20 as desired. In certain embodiments, the displays are positioned on frame 28 at player ends 20a of table 20. Additionally, in other embodiments, the displays may be positioned along the outer vertical sides of frame 28, so that audience members can see the displays when illuminated.

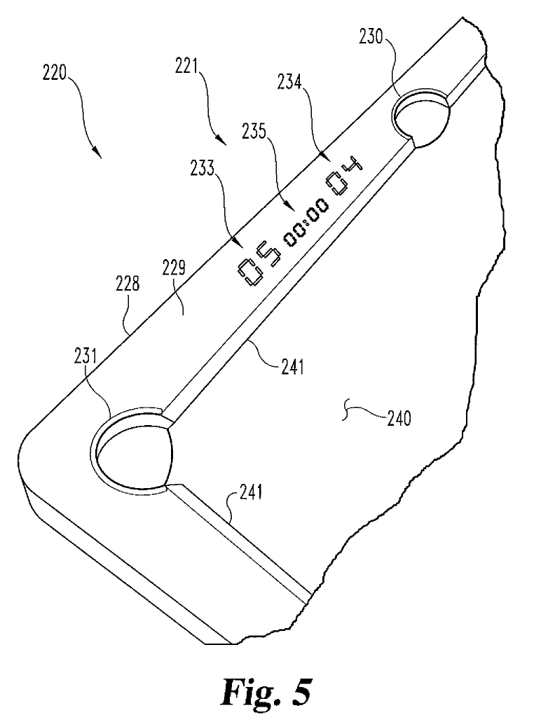

As another example, FIG. 5 illustrates a hidden scoring display used with a billiards game table 220. For clarity and simplicity, only a portion of the table is shown in FIG. 5. In certain embodiments, game table 220 is a standard billiards table. In certain other embodiments, game table 220 is a multi-game table configured to be arrangeable as both a billiards table and to play one or more other games such as air hockey, bumper pool, table tennis or soccer.

Table 220 is a generally standard style of game table having legs supporting a polygonal table bed. In certain embodiments, table 220 includes a frame or railing 228 mounted to the table bed. Frame 228 surrounds and extends above a game playing surface 240 a height normally sufficient to block escape of billiards balls from the table. In certain embodiments, surface 240 is composed of a felt material suitable for playing the game of billiards. The game playing surface may be mounted to the frame 228 or extend underneath the lower edges of frame 228. Playing surface 240 may rest in place or can be attached using standard methods such as adhesive, friction, screws, bolts or other permanent or removable connectors.

Additionally, frame 228 may define a plurality of billiards pockets sized and configured for the passage of billiards balls. In certain embodiments, there are four billiards pockets at the corner areas of the game table and two billiards pockets midway along the sides of the table. The portion of game table 220 illustrated in FIG. 5 include a center billiards pocket 230 and a corner billiards pocket 231 for passage of billiards balls. The billiards balls may pass through the billiards pockets and optionally return to one or more exit openings defined in the table bed through which a user of the game table may retrieve the balls.

In certain embodiments, frame 228 may also include a plurality of rubber or felt bumpers 241 positioned around the inside perimeter of the frame, extending between the billiards pockets. During the game of billiards, the billiards balls may contact and rebound from bumpers 241. In certain embodiments, bumpers 241 are integral portions of frame 228. In certain other embodiments, bumpers 241 are mounted to frame 228 via standard connection and/or attachment methods. Bumpers 241 may be composed of wood, rubber or another such appropriate material and may be optionally covered with a felt material.

Game table 220 further includes at least one hidden display 221 incorporated into frame 228. Similar to display 21, in certain embodiments display 221 is comprised of an LED display unit mounted with the railings defining frame 228. Frame 228 preferably includes one or more pieces or sheets of covering 229 positioned over the railings and thus covering the LED display unit mounted within the frame. In such embodiments, the LEDs on the display unit will illuminate through covering 229 to reveal the illuminated display 121.

As discussed above with reference to covering 29, covering 229 may be composed of a relatively thin, flexible, plastic film material and may be decorated, designed and/or colored in a variety of different ways such that covering 229 is sufficiently opaque to conceal the LED display unit when not in use. The covering 229 is also preferably sufficiently transparent such that illumination from the LEDs transmits through the covering 229 to display game status information. In a particular embodiment, covering 229 is decorated in a wood pattern and the LEDs producing display 221 are red colored LEDs configured to produce red light which illuminates through the wood pattern. However, it should be appreciated that the numbers and/or letters of display 221 may be displayed in other relatively bright, visible colors, such that the letters and/or numbers are visible through covering 229. The numbers and/or letters may also be shown in multiple colors, as desired. Further, the numbers and/or letters shown in display 221 are preferably sized large enough so that they are visible to players playing a game on table 220, as well as any members of an audience watching the game, but not so large as to provide a distraction to the game or be difficult to easily read.

The illustrated example shows one display 221 located between a corner billiards pocket 231 and a center billiards pocket 230 of table 220. In certain embodiments, another hidden display may be located on the opposing side of the game table, diagonally mirrored across a center point of the game table. In yet other embodiments, table 220 could include more than two displays as desired. Additionally, the display(s) can be positioned at other locations along the sides and/or ends of table 220 as desired. In other embodiments, the displays may be positioned along the outer sides of frame 228, so that audience members can easily see the displays when illuminated.

In the illustrated example, hidden display 221 has different display portions including a first score 233, a second score 234, and a timer 235. However, it should be appreciated that the hidden display could show only the score display. Further, the display could show other game status indicators as would occur to one skilled in the art. As examples, the projection display may show the player's turn, the team names, the high scores, the scoring records, etc. In embodiments in which game table 220 is a multi-game table also arrangeable as an air hockey table, the display may show the period of the game, the time elapsed or remaining in the period or the game, the possession of the puck, etc. Also, in certain embodiments the display may include words such as “Player 1” and “Player 2” to differentiate the first and second scores. In the illustrated example, the score of the billiards game is 5 to 4, and the timer portion of the display is not activated as a typical billiards game is not timed.

In the embodiments discussed above, displays 21 and/or 221 are electronic, displaying information using LED technology. In certain embodiments, the LEDs are provided in bright and/or contrasting colors so that the illumination from the LEDs transmits through the covering 29, such as green, blue or red, as examples. The LEDs may be provided in a segmented display composed of illuminated segments, including a 7-segment display as an example. In such embodiments, the segments are controlled on an individual basis to allow for selective illumination of segments on the display to provide any desired illumination pattern. In other embodiments, a plurality of LED lamps may be used to create the desired illumination pattern. It should be appreciated that other lighting techniques may be used to display the game status indicators, such as panels having fiberoptic feeds. In alternative embodiments, incandescent lamps may optionally be used to provide the illuminated displays.

In certain embodiments, sensors (not shown) may be positioned in scoring locations on the game tables, and, when activated, automatically send score signals to controllers mounted within the tables. In a particular embodiment, sensors may be associated with the hockey goals 42 on game table 20 operable to detect passage of the hockey puck 45 through the respective opening. Such sensors may be electrically coupled to the electrical controller of the game table. The controller then forwards the appropriate signals to the display unit 52 to update the game status information shown via hidden display 21. In other embodiments, the displays may be mechanically or manually driven or activated. In certain embodiments, displays 21 and/or 221 may also include manual controls for on/off power, starting, stopping or pausing a game or for manually adjusting a desired score or timer of the game.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed is:

1. A game table, comprising:
a game table having a game playing surface and a railing;
wherein said railing extends around the perimeter of said game playing surface and extends at least slightly above said game playing surface to prevent escape of a game playing piece from said game playing surface, said railing having a top surface;
wherein said game table includes at least one display unit having a display screen, said display unit being mounted within said railing such that said display screen is positioned substantially flush with or slightly below said top surface of said railing, said display unit being operable to illuminate to provide game status information when lit;
wherein said game table includes a covering positioned over said display screen, said covering being configured to substantially conceal said display unit beneath said covering when not lit, yet allows illumination from said display unit to transmit through said covering when lit; and
wherein said game table includes an electrical controller electrically coupled to said display unit.

2. The game table of claim 1, wherein said covering is tinted with a dark color to substantially conceal said display unit.

3. The game table of claim 1, wherein said covering is a thin film composed of a substantially flat and planar material piece.

4. The game table of claim 1, wherein said display unit includes an LED display configured to provide illumination.

5. The game table of claim 4, wherein said LED display is a segmented display composed of separate illuminated segments controlled on an individual basis.

6. The game table of claim 4, wherein said LED display includes a plurality of LED lamps.

7. The game table of claim 1, wherein said game table is rectangular in shape having two parallel, opposing player ends and two parallel, opposing longitudinal sides, wherein said game table includes two of said display units, said display units being centrally and oppositely positioned along said opposing longitudinal sides.

8. The game table of claim 1, wherein said game table may further include one or more manual control buttons operably coupled to said display unit.

9. The game table of claim 1, wherein said game table is a hockey game table having opposing goal openings centrally positioned along said opposing player ends, wherein said game table includes at least one sensor positioned at each of said goal openings operable to detect passage of a playing piece through said respective opening, said sensor being electrically coupled to said electrical controller.

10. The game table of claim 1, wherein said covering includes a top surface and has a thickness, wherein said display screen is positioned below said top surface of said railing a distance substantially equal to the thickness of said covering, wherein said covering is positioned over said display screen such that said top surface of said covering is substantially flush with said top surface of said railing.

11. The game table of claim 1, wherein said display screen is positioned substantially flush with said top surface of said railing and said covering is positioned over said display screen and at least part of said top surface of said railing.

12. A game table, comprising:
a game table having a game playing surface, a display covering and a railing extending around the perimeter of and slightly above said game playing surface, said railing having a top surface;
wherein said game table includes a display unit having a display screen, said display unit being embedded within said railing with said display covering positioned over said display screen, wherein said covering is illuminated from behind to allow illuminated game status information from said display unit to be visible; and
wherein said covering is configured to substantially conceal said display unit beneath said covering when not lit, yet allows illumination from said display unit to transmit through said covering when lit.

13. The game table of claim 12, wherein said display unit is mounted within said railing such that said display screen is positioned substantially flush with said top surface of said railing.

14. The game table of claim 12, wherein said display unit is mounted within said railing such that said display screen is positioned below said top surface of said railing.

15. The game table of claim 14, wherein said covering includes a top surface and has a thickness, wherein said display screen is positioned below said top surface of said railing a distance substantially equal to the thickness of said covering, wherein said covering is positioned over said display screen such that said top surface of said covering is substantially flush with said top surface of said railing.

16. The game table of claim 12, wherein said display unit includes an LED display configured to provide illumination.

17. A hockey game table, comprising:
a hockey game table having first and second parallel player ends along a width direction, first and second parallel longitudinal sides along a length direction, and a game playing surface defined within said player ends and said longitudinal sides, wherein each of said player ends includes a goal, wherein said hockey game table includes a railing extending around the perimeter of said game playing surface and extending at least slightly above said game playing surface to prevent escape of a game playing piece from said game playing surface, said railing having a top surface;
wherein said game table includes at least one display unit having a display screen, said display unit being embedded within said railing, said display unit being operable to illuminate to provide at least one game status indicator when lit, said game status indicator including the score of the game being played on said game table;
wherein said game table includes a covering positioned over said display screen, said covering being configured to substantially conceal said display unit beneath said covering when not lit, yet allows illumination from said display unit to transmit through said covering when lit, said covering having a top surface, wherein either said top surface of said covering or said display screen is positioned substantially flush with said top surface of said railing; and
wherein said game table includes an electrical controller electrically coupled to said display unit and operable to transmit signals to said display unit to update the score of the game illuminated through said covering;
wherein said game table includes at least one sensor associated with each of said goal openings operable to detect passage of a playing piece through said respective opening, said sensor being electrically coupled to said electrical controller and operable to transmit scoring signals to said electrical controller.

18. The game table of claim 17, wherein said display unit includes an LED display configured to provide illumination.

19. The game table of claim 17, wherein said game table includes two of said display units centrally and oppositely positioned along said opposing longitudinal sides.

20. The game table of claim 17, wherein said covering includes a top surface and has a thickness, wherein said display screen is positioned below said top surface of said railing a distance substantially equal to the thickness of said covering, wherein said covering is positioned over said display screen such that said top surface of said covering is substantially flush with said top surface of said railing.

21. The game table of claim 17, wherein said display screen is positioned substantially flush with said top surface of said railing and said covering is positioned over said display screen and at least part of said top surface of said railing.
